(19) United States
(12) Patent Application Publication
(10) Pub. No.: US 2009/0067825 A1
(43) Pub. Date: Mar. 12, 2009

(54) Portable photo booth

(76) Inventors: Dale Valvo, Bedford, NH (US); Yefim Massarsky, Newton, MA (US)

Correspondence Address: DEVINE, MILLIMET & BRANCH, P.A., 111 AMHERST STREET, BOX 719, MANCHESTER, NH, 03105, US

(21) Appl. No.: 12/229,255

(22) Filed: Aug. 21, 2008

Related U.S. Application Data
(60) Provisional application No. 60/965,611, filed on Aug. 21, 2007.

(51) Int. Cl. G03B 15/00

(52) U.S. Cl. 396/2

(57) ABSTRACT

A more fully-portable photo booth that is fully-collapsible into a relatively small, portable package that can be repeatedly moved, set up and taken down by a single person.

### CROSS-REFERENCE TO RELATED APPLICATIONS

The present application claims the benefit of provisional patent application Ser. No. 60/965,611 filed Aug. 21, 2007, which is incorporated herein by reference.

### TECHNICAL FIELD

The present invention relates to a fully-portable image capture, display and printing system.

### BACKGROUND OF THE INVENTION

Portable-image capture, display and printing systems (“photo booths”) are described in the prior art. Although such systems provide tremendous entertainment value and an attractive printed output, these photo booths are relatively large, semi-permanent structures. Accordingly, users must come to the photo booths in order to experience the entertainment value associated with them. It is an object of the present invention to provide a more fully-portable photo booth that is fully-collapsible into a relatively small, portable package that can be moved by a single person, can be repeatedly set up and taken down, and can be transported on airplanes and in motor vehicles. As a result, this photo booth can be transported to users rather than the users having to come to the system.

In addition, the photo booths of the prior art were arranged so that the photographs were delivered in the space in which a person sat for a photograph. Thus, a second person could not sit for a photograph until the photographs of his predecessor were delivered. It is an object of the present invention to deliver the photographs in a different space allowing a second person to sit for a photograph while his predecessor's photographs are being printed and delivered.

### SUMMARY

The present invention comprises a portable photo booth. This photo booth is used to capture a photograph of one or more users, display the photograph on a monitor and print the photograph. This photo booth is fully-collapsible into a relatively small, portable package that can be moved and repeatedly set up and taken down by a single person.

### BRIEF DESCRIPTION OF THE DRAWINGS

These and other features and advantages of the present invention will be better understood by reading the following detailed description, taken together with the drawings wherein:

FIG. 1 shows the first shipping case and the first box of the photo booth of the present invention;

FIG. 2 shows the second shipping case and the second box of the photo booth of the present invention;

FIG. 3 shows the first box mechanically latched to the second box of the photo booth of the present invention;

FIGS. 4a-4c show the latching means of the photo booth of the present invention;

FIG. 5 shows the structure of the photo booth of the present invention; and

FIG. 6 shows the canopy of the photo booth of the present invention.

### DETAILED DESCRIPTION OF PREFERRED EMBODIMENTS

The present invention comprises a portable photo booth. This photo booth is used to capture a photograph of one or more users, display the photograph on a monitor and print the photograph. This photo booth is fully-collapsible into a relatively small, portable package that can be moved and repeatedly set up and taken down by a single person.

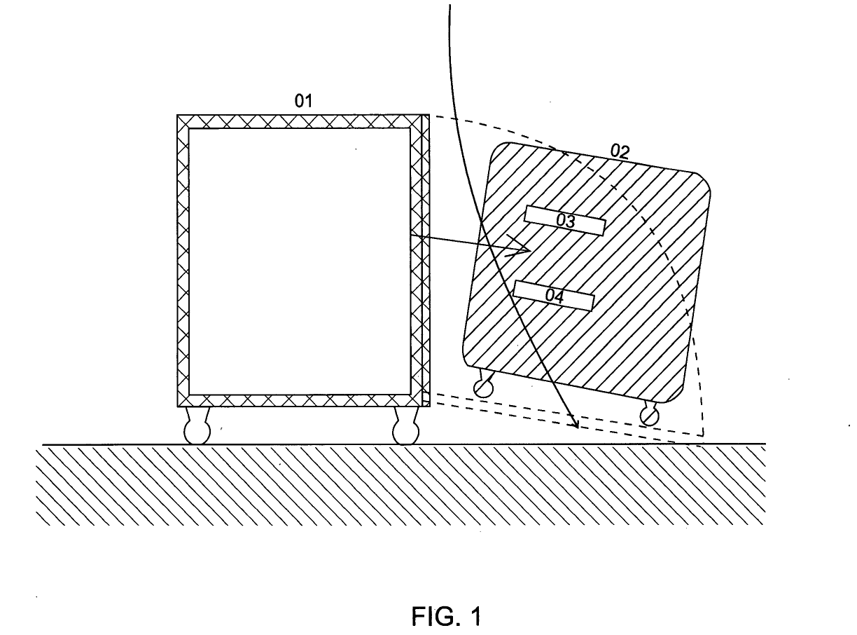

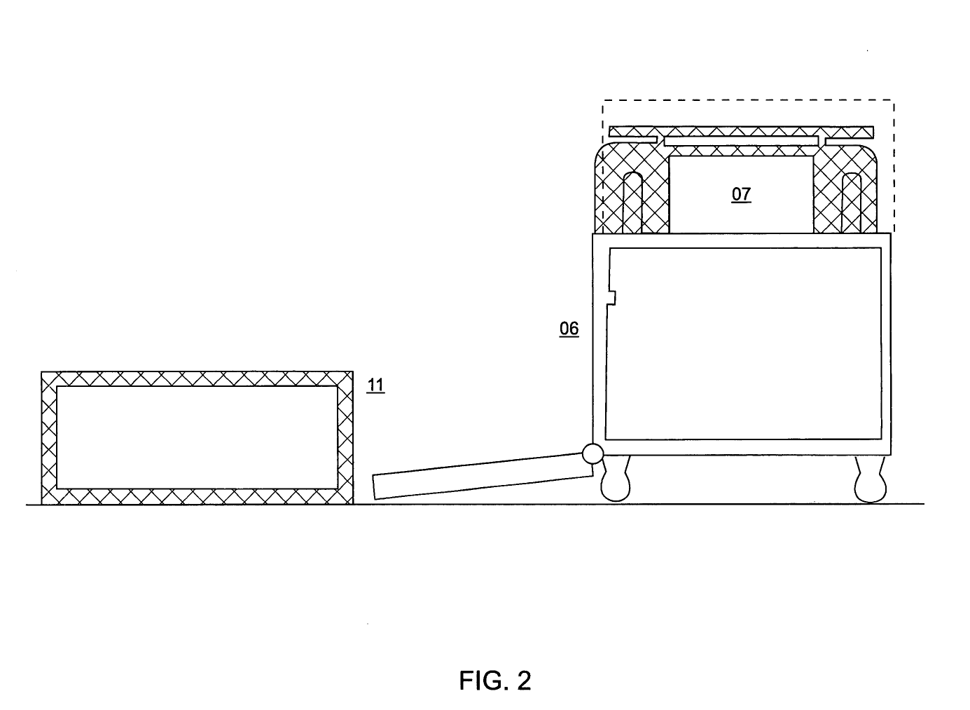

As shown in FIGS. 1-3, a preferred embodiment of the present invention includes a shipping case 01 for shipping a printer box 02 containing multiple printers 03, 04 to provide redundancy in printing. It also includes another shipping case 06 for shipping a monitor box 07 containing a display monitor 08 and an image acquisition device 09, which includes without limitation, a film camera or a digital still or video camera. It also includes a general purpose computer 10 for saving and processing the acquired images and creating on the monitor 08 a display of the acquired images and printing on printers 03, 04 the acquired images.

The cover 11 of shipping case 06, as described in more detail below, is used as a seat for persons using the photo booth. It should be understood that configuring shipping case 01 with a top that can be used as such a seat is an equivalent to configuring shipping case 06 with a cover to be used as such a seat.

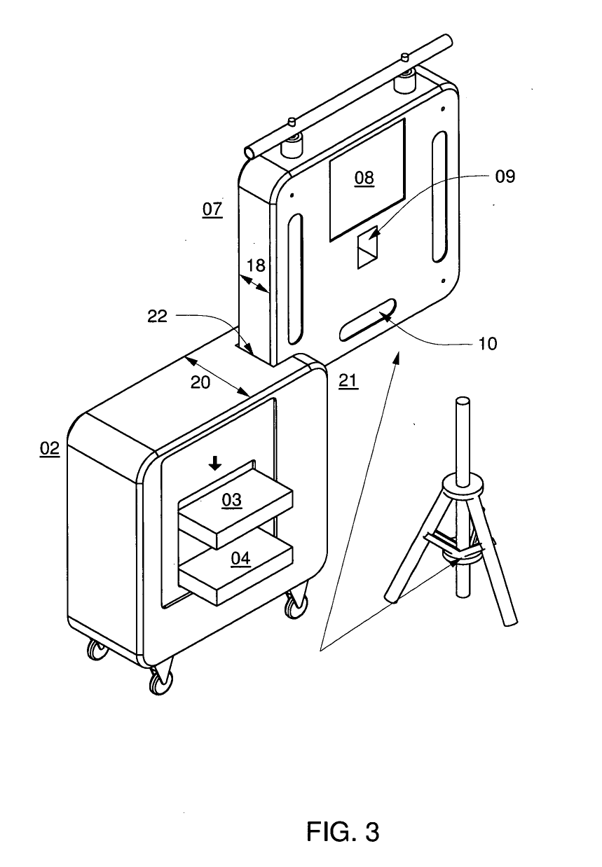

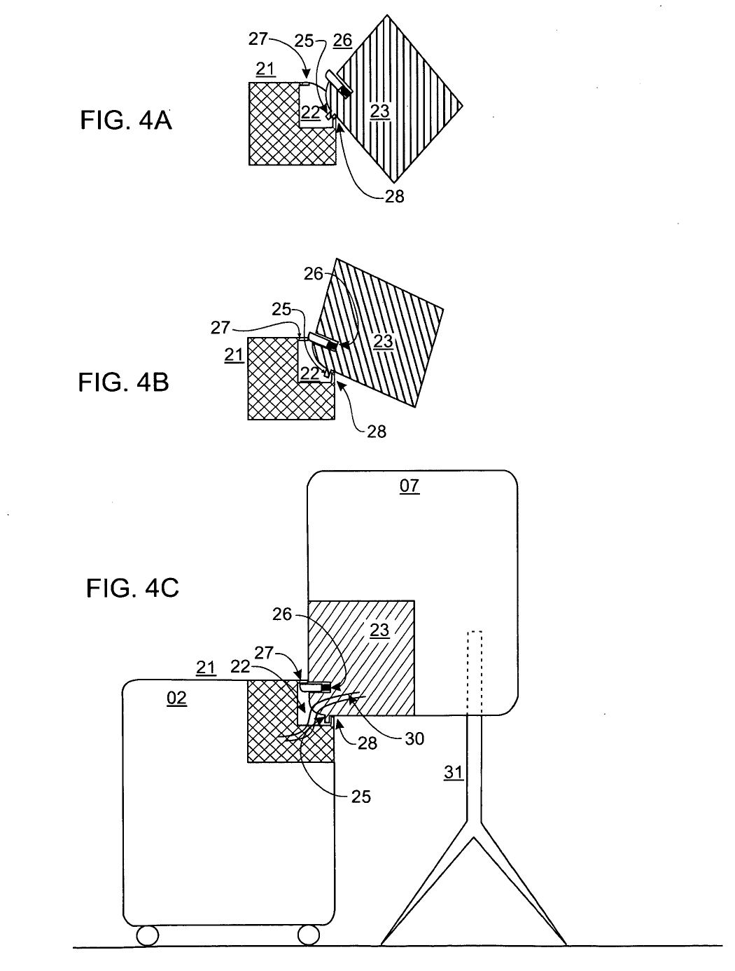

As is shown in FIG. 3, the depth 19 of monitor box 07 is smaller than the depth 20 of printer box 02. In addition, an upper corner 21 of the printer box 02 has a recess 22 so that a lower corner 23 of monitor box 07 can fit into the recess 22. As is shown in FIGS. 4a-4c, the lower corner 23 of monitor box 07 has a protrusion 25 and a spring loaded latch 26. The recess 22 in the upper corner 21 of the printer box has a top lip 27 at its top and a bottom lip 28 at its bottom 28. Thus, the lower corner 23 of the monitor box 07 can be inserted into the recess 22 in the upper corner 21 of the printer box 02 such that the protrusion 25 on the monitor box 02 engages the bottom lip 28 at the bottom of the recess 22. The monitor box is then rotated so that the latch 26 engages the top lip 27 at the top of the recess 22, causing the monitor box 07 to be mechanically latched to the printer box 02. The monitor box 07 can be unlatched from the printer box 02 by releasing the latch 26.

FIG. 4c shows wires 30 electrically attaching the computer 10 in the monitor box 07 to the printers 03, 04 in the printer box 02. The wires 30 can be attached by male-female electrical connectors or a number of other types of connectors known to those skilled in the art, that allow the wires easily to be attached and unattached. Alternatively, the computer in the monitor box 07 can be electrically attached to the printer in the printer box 02 wirelessly. FIG. 4c also shows a support member 31, in this embodiment a tripod, connected to the monitor box 07, extending from the monitor box 07 to the floor. The support member acts to prevent the mechanically latched monitor box 07 and printer box 02 from tipping over.

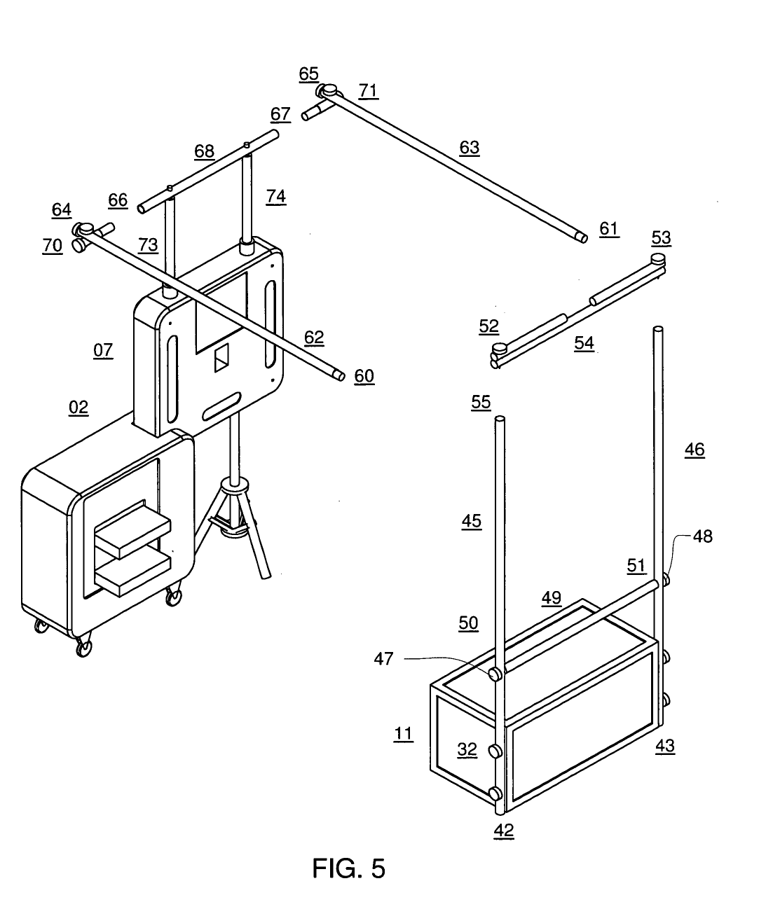

As shown in FIG. 5, a preferred embodiment of the portable photo booth of the present invention uses the cover 11 of shipping case 06 as a seat for persons desiring to use the photo booth. The cover 11 has a first side 32 and a second opposing side 33. The first end of 42 of first vertical member 45 is attached to the first side 32 of the cover 11, and the first end 43 of second vertical member 46 is attached to the second side 33 of the cover 11. The first and second ends 47, 48 of a midsection cross-member 49 are attached to the midsections of 50, 51 of the first and second vertical members 45, 46, respectively. Also, the first and second ends of 52, 53 of a top cross-member 54 are attached to the second ends 55, 56 of the first and second vertical members 45, 46, respectively.

The first ends 60, 61 of first and second horizontal members 62, 63, respectively, are connected to the second ends 55, 56 of the first and second vertical members 45, 46, respectively. The second ends 64, 65 of the first and second horizontal members 62, 63, respectively, are connected to first and second ends 66, 67 of a tensioning member 68 such that the tensioning member 68 can be adjusted by moving it forward or away from the second ends 64, 65 of the horizontal members 62, 63, respectively, through the use of tensioning screws 70, 71. Connecting members 73, 74 connect the tensioning member to the monitor box 07.

It should be understood that the various members described above are connected to each other and the cover in this embodiment through the use of thumbscrews being screwed into tapped holes allowing for easy connection and disconnection. Other means for making these connections known to those skilled in the art can be used.

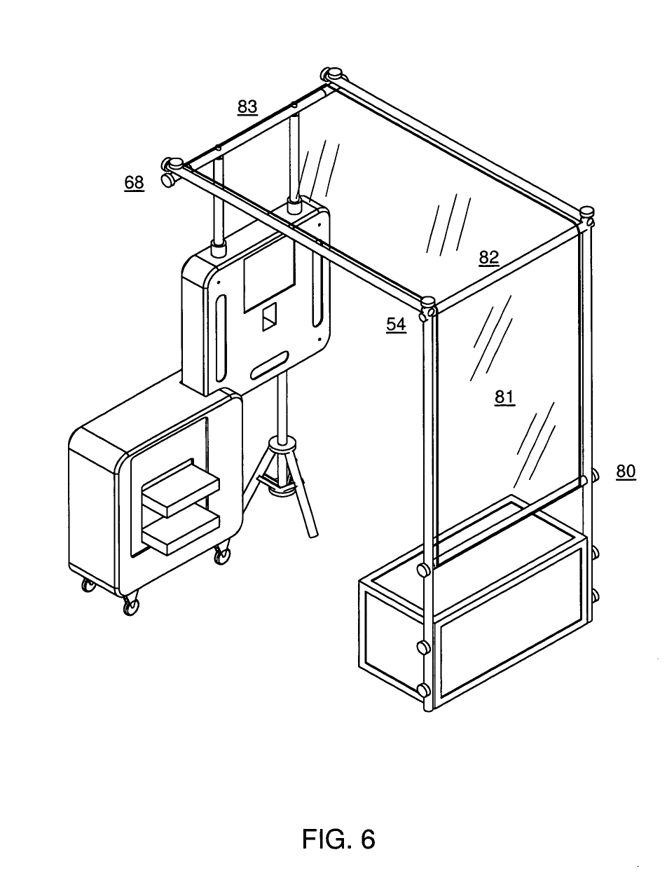

As shown in FIG. 6, the first end 80 of canopy 81 is connected to the mid-section cross-member 49, a mid-section 82 of the canopy 81 rests on the top cross-member 54 and the second end 83 of the canopy 81 is connected to the tensioning member 68. The ends of the canopy are connected to the mid-section cross-member and the tensioning bar by any one of a number of means known to those skilled in the art. The tensioning screws 70, 71 can adjust the tensioning bar 68 so that tension is placed on the canopy 81, which provides rigidity to the photo booth.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A portable photo booth comprising,
a first shipping case for shipping a first box containing a printer;
a second shipping case with a cover with a first side and a second side for shipping a second box containing an image acquisition device, a monitor, and a computer;
means for mechanically latching, and means for electrically attaching, a corner of the first box to a corner of the second box;
a first vertical member with a first end connected to the first side of the cover, a midsection connected to a first end of a midsection cross member, and a second end connected to a first end of a top cross member; and a second vertical member with a first end connected to the second side of the cover, a midsection connected to a second end of the midsection cross member, and a second end connected to a second end of the top cross member;
a first horizontal member with a first end connected to the second end of the first vertical member and a second end connected to a first end of a tensioning member, and a second horizontal member with a first end connected to the second end of the second vertical member and a second end connected to a second end of the tensioning member;
a canopy with a first end connected to the midsection cross member, a midsection resting on top of the top cross member and a second end connected to the tensioning member; and
means for moving the tensioning member toward or away from the second ends of the first and second horizontal members.

2. The portable photo booth of claim 1 further comprising,
a first support member connected to the second box and extending to a floor; and
a second support member with a first end connected to the tensioning member and a second end connected to the second box.

3. A portable photo booth comprising,
a first shipping case for shipping a first box containing a printer;
a second shipping case with a cover with a first side and a second side for shipping a second box containing an image acquisition device, a monitor, and a computer; and
means for mechanically latching, and means for electrically attaching, a corner of the first box to a corner of the second box.
